(19) United States
(12) Patent Application Publication
(10) Pub. No.: US 2025/0333022 A1
(43) Pub. Date: Oct. 30, 2025

(54) DOOR LOCK CONTROL APPARATUS

(71) Applicant: SUBARU CORPORATION, Tokyo (JP)

(72) Inventors: Masato SATO, Tokyo (JP); Shouta SUZAWA, Tokyo (JP); Kazuki TOMIMATSU, Tokyo (JP)

(21) Appl. No.: 19/096,823

(22) Filed: Apr. 1, 2025

(30) Foreign Application Priority Data
Apr. 24, 2024 (JP) 2024-070536

(51) Int. Cl. B60R 25/24

(52) U.S. Cl. CPC B60R 25/245

(57) ABSTRACT

A door lock control apparatus configured to be applied to a vehicle includes a communicator and a processor. When detecting that a portable device has entered a first region set to be greater than or equal to a second distance and less than a first distance, the processor performs authentication between the portable device and the vehicle. When detecting that the portable device has entered a second region set to be less than the second distance from the vehicle, the processor refrains from permitting unlocking of the door lock mechanism even when the authentication is established, provided that one or both of a movement amount and a movement time of the portable device in the first region from when the portable device has entered the first region until when the portable device has entered the second region are greater than or equal to a respective predetermined threshold.

### CROSS-REFERENCE TO RELATED APPLICATIONS

The present application claims priority from Japanese Patent Application No. 2024-070536 filed on Apr. 24, 2024, the entire contents of which are hereby incorporated by reference.

### BACKGROUND

The disclosure relates to a door lock control apparatus to be applied to a vehicle, and more particularly, to a door lock control apparatus that controls locking and unlocking of a door lock mechanism by mutual communication between the vehicle and a portable device.

In recent years, various techniques have been proposed that establish wireless communication between a portable device, such as small communication equipment usable as an electronic key or a digital key, and a vehicle, detect that the portable device has approached a predetermined distance range from the vehicle, and unlock a door lock of the vehicle.

As an example of such a technique, Japanese Unexamined Patent Application Publication (JP-A) No. 2017-210800 discloses a keyless system in which, when a portable device is positioned in a low frequency (LF) communication area, the portable device receives a challenge signal transmitted from an in-vehicle device, and when the portable device is stationary for a predetermined time period or longer, the portable device transmits a response signal to the in-vehicle device. The keyless system unlocks a door when authentication of the portable device is established in the in-vehicle device by the transmission and reception of the signals.

JP-A No. 2016-014259 discloses an electronic key device that establishes communication between an in-vehicle device including a plurality of antennas provided at different positions of a vehicle and a portable device, and unlocks a door when the portable device is heading toward any of the antennas, and a distance between the vehicle and the portable device is less than or equal to a predetermined threshold.

### SUMMARY

An aspect of the disclosure provides a door lock control apparatus configured to be applied to a vehicle. The door lock control apparatus is configured to control locking and unlocking of a door lock mechanism of a door of the vehicle. The door lock control apparatus includes a communicator and a processor. The communicator is configured to mutually communicate with a portable device. The processor is configured to control the door lock mechanism, based on a signal received from the portable device via the communicator. The processor is configured to set a first distance that is a predetermined distance from the vehicle and a second distance shorter than the first distance, and to, when detecting that the portable device has entered a first region set to be greater than or equal to the second distance and less than the first distance, perform authentication between the portable device and the vehicle, and configured to, when detecting that the portable device has entered a second region set to be less than the second distance from the vehicle, refrain from permitting unlocking of the door lock mechanism even when the authentication is established, provided that one or both of a movement amount and a movement time of the portable device in the first region from when the portable device has entered the first region until when the portable device has entered the second region are greater than or equal to a respective predetermined threshold.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is an explanatory diagram illustrating a schematic configuration of a vehicle control system including a door lock control apparatus according to one example embodiment of the disclosure.

FIG. 2 is an explanatory diagram of regions to be set around a vehicle and non-limiting examples of a behavior of a user who carries a portable device in the regions.

FIG. 3 is an explanatory diagram of the regions to be set around the vehicle and non-limiting examples of the behavior of the user who carries the portable device in the regions.

FIG. 4 is a flowchart illustrating how a door lock mechanism is controlled by the door lock control apparatus illustrated in FIG. 1.

### DETAILED DESCRIPTION

A door lock mechanism locks and unlocks a door by driving an actuator. When unnecessary unlocking of the door is repeatedly performed unintentionally, power consumption may possibly increase.

What is desired is to reduce power consumption by preventing unnecessary unlocking as much as possible.

It is desirable to provide a door lock control apparatus to be applied to a vehicle that makes it possible to reduce power consumption by distinguishing between a user who intends to ride a vehicle and a user who does not intend to ride the vehicle, thereby preventing unnecessary unlocking as much as possible.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

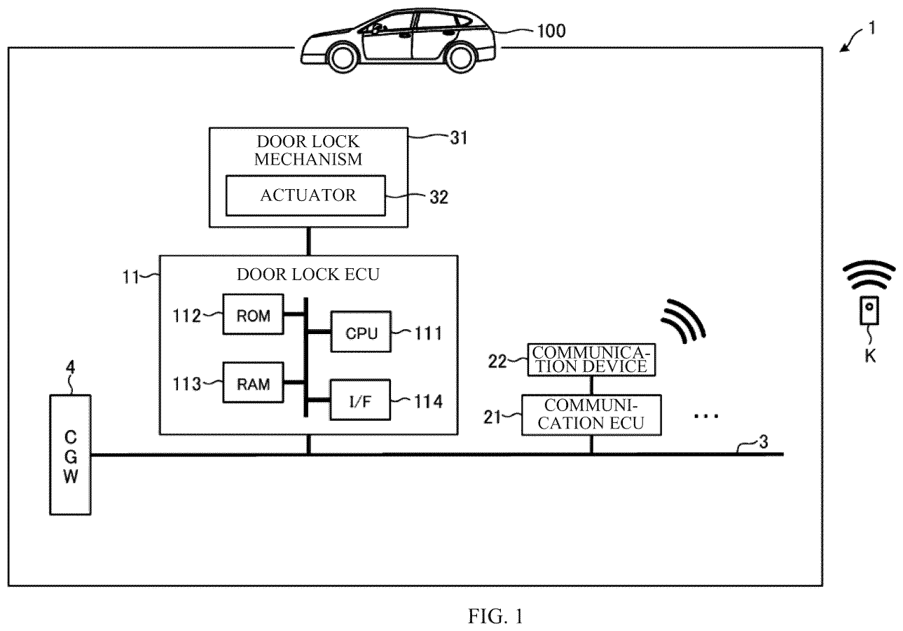

As illustrated in FIG. 1, a door lock control apparatus according to an example embodiment may serve as part of a vehicle control system 1. The vehicle control system 1 may be mounted on a vehicle 100. The vehicle control system 1 may include a plurality of sensors, various electronic devices, and a plurality of electronic control units (ECUs) that controls the sensors and the electronic devices. The sensors may acquire various kinds of data indicating a traveling state of the vehicle 100 and environments inside and outside the vehicle 100. The electronic devices may be used for traveling of the vehicle 100.

The sensors, the electronic devices, and the ECUs may be communicably coupled to each other by any network including, for example but not limited to, an in-vehicle network 3, such as a controller area network (CAN) or a local interconnect network (LIN), and a central gateway (CGW) 4. The central gateway (CGW) 4 may serve as a relay device. The vehicle control system 1 illustrated in FIG. 1 may be an example. In some embodiments, the vehicle control system 1 may include no CGW 4. In this case, the ECUs may directly or indirectly communicate with each other.

In the vehicle control system 1, data acquired by each of the sensors may be outputted to the in- vehicle network 3, and data indicating an operation state of an electronic device to be controlled may be outputted from each of the ECUs to the in-vehicle network 3. Hereinafter, the electronic device to be controlled may be referred to as a control target device. Further, each of the ECUs may control an operation of the corresponding control target device, based on the data from the sensors and other ECUs acquired through the in-vehicle network 3.

Each of the ECUs may include, for example but not limited to, a processor such as a central processing unit (CPU) or a micro processing unit (MPU). The processor may execute various kinds of processes. Each of the ECUs may include a volatile storage device such as a random access memory (RAM) and a nonvolatile storage device such as a read only memory (ROM). The RAM may temporarily process data to be used by the processor. The ROM may store, for example but not limited to, programs to be executed by the processor and other components.

FIG. 1 illustrates the door lock ECU 11 and a communication ECU 21 out of the plurality of ECUs. Illustration of other ECUs is omitted. In the example embodiment, detailed description and illustration of ECUs, sensors, and electronic devices that do not participate in an operation of the door lock ECU 11 are omitted even if these components are included in the vehicle control system 1. In one embodiment, the door lock ECU 11 may serve as a “door lock control apparatus”. A description is given of the door lock ECU 11 and the communication ECU 21 illustrated in FIG. 1.

The door lock ECU 11 may be coupled to a door lock mechanism 31 and locks or unlocks the door lock mechanism 31 by controlling driving of an actuator 32 of the door lock mechanism 31.

For example, the door lock ECU 11 may control locking or unlocking of the door lock mechanism 31 by driving the actuator 32 in accordance with a lock signal or an unlock signal based on an operation on a switch provided in an interior of the vehicle 100, or in accordance with a lock signal or an unlock signal based on a signal emitted from a portable device K. It is possible for the door lock ECU 11 to individually control the door lock mechanism 31 provided in each of doors of the vehicle 100.

Here, the portable device K may be, for example but not limited to, small movable communication equipment configured to perform range measurement and positioning by short-range wireless communication such as Ultra Wideband (UWB), Bluetooth (registered trademark), or Bluetooth Long Energy (BLE). Such small movable communication equipment may include general-purpose communication equipment such as a smartphone or a smart watch. It is possible for the portable device K to serve as what is called a digital key by installing a predetermined application in the portable device K in advance. In addition, a dedicated electronic key configured to be communicable with the vehicle 100 may be used as the portable device K.

As illustrated in FIG. 1, the door lock ECU 11 may include a CPU 111, a ROM 112, a RAM 113, and an I/F 114. The door lock ECU 11 may control the door lock mechanism 31 by executing various processes based on programs stored in the ROM 112 by the CPU 111.

The ROM 112 provided as the nonvolatile storage device may hold control programs adapted to perform authentication of the portable device K and control the door lock mechanism 31, and various kinds of data to be used to execute the control programs. The various kinds of data may include unique identification (ID) data adapted for identifying the vehicle 100, i.e., the door lock ECU 11, which may hereafter be referred to as a vehicle ID, and ID data adapted for identifying the portable device K, which may hereafter be referred to as a device ID. The vehicle ID and the device ID may be used for authenticating the portable device K.

The RAM 113 provided as the volatile storage device may be used as a work area when the CPU 111 executes various kinds of processes. Various kinds of data outputted from the ECUs and the sensors on the in-vehicle network 3 may therefore be temporarily stored in the RAM 113 as needed.

The CPU 111 may read the programs stored in the ROM 112 into, for example, a memory such as the RAM 113 and execute the programs, thereby controlling the door lock mechanism 31, based on the signal received from the portable device K.

The I/F 114 may control input and output of various kinds of data and control signals to be used in the door lock ECU 11. For example, the I/F 114 may receive various kinds of data outputted from the ECUs and the sensors of the vehicle control system 1 to the in-vehicle network 3, and output a control signal generated in the CPU 111 to an output destination corresponding to control contents. In one embodiment, the CPU 111 may serve as a “processor”.

When the door lock ECU 11 is to perform authentication of the portable device K, the I/F 114 may receive a signal that is emitted from the portable device K and received by a communicator 22, and output, to the in-vehicle network 3, a signal including the vehicle ID to be transmitted from the communicator 22 to the portable device K. In some embodiments, the I/F 114 may be configured to be wirelessly communicable to allow a signal to be directly transmitted and received between the door lock ECU 11 and the portable device K. In addition, when the door lock mechanism 31 is to be locked, the I/F 114 may output a lock signal to the door lock mechanism 31, and when the door lock mechanism 31 is to be unlocked, the I/F 114 may output an unlock signal to the door lock mechanism 31.

The communication ECU 21 may be coupled to the communicator 22 and control transmission and reception of signals in the communicator 22. The communicator 22 may include a transmission antenna and a reception antenna, which are not illustrated, and transmit a predetermined signal to the portable device K and receive a signal emitted from the portable device K.

When the door lock ECU 11 is to perform authentication of the portable device K, the communication ECU 21 may receive the signal including the device ID transmitted from the portable device K through the communicator 22 and output the signal to the door lock ECU 11. Further, the communication ECU 21 may acquire, from the door lock ECU 11, data including the vehicle ID to be used for the authentication, and cause a signal including the data to be transmitted from the communicator 22 to the portable device K.

Next, a description is given of a control of the door lock mechanism 31 to be performed by the door lock ECU 11. The door lock mechanism 31 may be controlled based on the signal received from the portable device K.

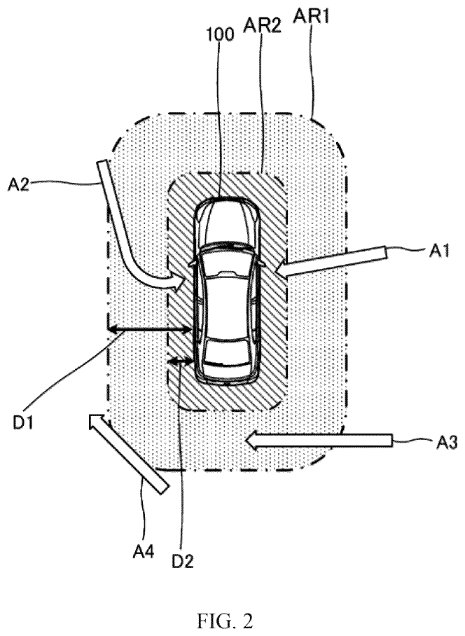

In FIG. 2, a first region AR1 set to be less than a first distance D1 from the vehicle 100 is indicated by stippling, and a second region AR2 set to be less than a second distance D2 from the vehicle 100 is indicated by hatching. The second region AR2 may include the vehicle 100. As illustrated in FIG. 2, the first distance D1 may be a distance longer than the second distance D2, and the first region AR1 may be a region set to the outer side of the second region AR2. In FIG. 2, white arrows A1 to A4 indicate movement histories of a user who carries the portable device K, i.e., movement histories of the portable device K.

The door lock ECU 11 may cause the communicator 22 to output a signal adapted for detection of the portable device K, at a predetermined cycle. However, when a distance from the vehicle 100 is greater than or equal to the first distance D1, communication between the communicator 22 and the portable device K may not be established, and in the region outside the first region AR1, the door lock ECU 11 may be unable to detect the presence of the portable device K.

In contrast, the communicator 22 and the portable device K may be communicable with each other in the first region ARI and the second region AR2, which are less than the first distance D1 from the vehicle 100, making it possible for the door lock ECU 11 to detect the portable device K. Consequently, when the portable device K is positioned in the first region AR1 or the second region AR2, it is possible for the door lock ECU 11 to grasp, for example, the position of the portable device K in the first region AR1 or the second region AR2, the time when the portable device K has passed through the position, and the distance from the vehicle 100.

The first region AR1 may be a region in which it is possible to perform authentication of the portable device K by communication between the communicator 22 and the portable device K. When the portable device K is positioned in the first region ARI, unlocking of the door lock mechanism 31 may not be permitted even when the authentication of the portable device K is established. When the portable device K is positioned in the second region AR2, unlocking of the door lock mechanism 31 may be permitted provided that the authentication of the portable device K is established and a condition to be described later is satisfied.

Upon detecting that the portable device K has approached the vehicle 100 and entered the first region AR1, the door lock ECU 11 may authenticate the portable device K, and record, in the RAM 113, movement data associated with the movement of the portable device K. The movement data may include, for example but not limited to, the position of the portable device K, the time when the portable device K has passed through the position, and the distance from the vehicle 100. For example, the RAM 113 may record the movement data of the portable device K for a certain time period. For example, the RAM 113 may record the movement history.

Not all users who carry the portable device K that has approached the vehicle 100 intend to unlock the door lock mechanism 31. Upon detecting that the portable device K has entered the second region AR2, the door lock ECU 11 may make a determination as to whether the user who carries the portable device K intends to ride on the vehicle 100, and control the door lock mechanism 31, based on a result of the determination.

Whether the user who carries the portable device K intends to ride on the vehicle 100 may be determined as follows.

Upon detecting that the portable device K has entered the second region AR2, the door lock ECU 11 may refer to the movement history of the portable device K that has been recorded in the RAM 113, and calculate a movement amount of the portable device K in the first region ARI from when the portable device K has entered the first region ARI until when the portable device K has entered the second region AR2. The movement amount may be represented by, for example but not limited to, a movement distance.

The door lock ECU 11 may determine that the user who carries the portable device K does not intend to ride on the vehicle 100 when the calculated movement amount is greater than or equal to a predetermined threshold, and determine that the user intends to ride on the vehicle 100 when the movement amount is less than the predetermined threshold.

Accordingly, when the movement amount is greater than or equal to the predetermined threshold, the door lock ECU 11 refrains from permitting unlocking of the door lock mechanism 31 even when the authentication of the portable device K is established. In contrast, when the movement amount is less than the predetermined threshold, the door lock ECU 11 may permit unlocking of the door lock mechanism 31 on condition that the authentication of the portable device K is established. The threshold for the movement amount may be set as appropriate, and a distance AD that corresponds to a difference between the first distance D1 and the second distance D2 may be set as the threshold, for example.

Because the door lock ECU 11 is unable to detect the portable device K outside the first region AR1, when the portable device K repeatedly enters the first region AR1 and exits to the outside of the first region AR1, the portable device K may be detected and undetected repeatedly.

In such a case, the door lock ECU 11 may calculate a cumulative movement amount of the portable device K in the first region AR1 from the point in time at which the portable device K has last entered the first region AR1 to the point in time when the portable device K has entered the second region AR2 within a predetermined time, and determine whether the user who carries the portable device K intends to ride on the vehicle 100, based on whether the cumulative movement amount exceeds a threshold.

FIG. 2 illustrates non-limiting examples of the movement history (arrows A1 to A4) of the user who carries the portable device K, or in other words, non-limiting examples of the movement history of the portable device K. A description of FIG. 2 is given on the premise that the door lock ECU 11 calculates the movement distance as the movement amount, and the distance AD, which is the difference between the first distance D1 and the second distance D2, is set as a threshold for the movement distance.

As illustrated in FIG. 2, when the portable device K moves along the arrow Al and enters the second region AR2 via the first region AR1, the movement distance of the portable device K in the first region AR1 may be less than the distance AD, which is the threshold. In this case, when the portable device K enters the second region AR2, unlocking of the door lock mechanism 31 may be permitted on condition that the authentication is established.

In contrast, when the portable device K moves along the arrow A2 and enters the second region AR2 via the first region AR1, the movement distance of the portable device K in the first region AR1 may exceed the distance AD, which is the threshold. In this case, when the portable device K enters the second region AR2, unlocking of the door lock mechanism 31 is not permitted even when the authentication is established.

When the portable device K moves along the arrow A3, the portable device K may move in the first region AR1 without entering the second region AR2, and the movement distance may exceed the distance AD. In this case, unlocking of the door lock mechanism 31 may not be permitted. When the portable device K moves along the arrow A4, unlocking of the door lock mechanism 31 may not be permitted because the portable device K enters the first region AR1 and thereafter moves outward of the first region AR1 without entering the second region AR2.

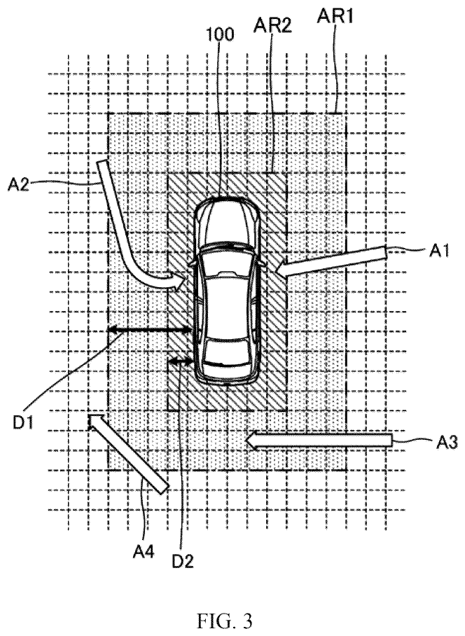

As in the example illustrated in FIG. 2, the movement distance by which the portable device K has moved may be applied as the movement amount. In addition, for example, as illustrated in FIG. 3, a virtual grid may be set in the first region AR1 and the second region AR2, and grid squares may be formed by the grid in each region. The movement amount may be calculated based on the number of grid squares through which the portable device K has moved.

In FIG. 3 also, similarly to FIG. 2, the first region AR1 set to be less than the first distance D1 from the vehicle 100 is indicated by stippling, and the second region AR2 set to be less than the second distance D2 from the vehicle 100 is indicated by hatching. As illustrated in FIG. 3, the first distance D1 may be a distance longer than the second distance D2, and the first region AR1 may be a region set to the outer side of the second region AR2. In FIG. 3, white arrows A1 to A4 indicate movement histories of the user who carries the portable device K, i.e., movement histories of the portable device K.

In FIG. 3, when the portable device K is moving along the arrow A1, the portable device K may enter the second region AR2 after moving through three grid squares in the first region AR1. For example, when the threshold set for the movement amount is four grid squares that exceed the distance AD, the movement amount corresponding to three grid squares in the first region AR1 may be less than the threshold. Because the movement amount is less than the threshold, when the portable device K enters the second region AR2, unlocking of the door lock mechanism 31 may be permitted on condition that the authentication is established.

In contrast, when the portable device K is moving along the arrow A2, the portable device K may enter the second region AR2 after moving through seven grid squares or more in the first region AR1. In this case, because the movement amount in the first region ARI is greater than or equal to four grid squares, which is the threshold, when the portable device K enters the second region AR2, unlocking of the door lock mechanism 31 may not be permitted even when the authentication is established.

Further, when the portable device K moves along the arrow A3, the portable device K may move through the first region AR1 by five grid squares. In this case, unlocking of the door lock mechanism 31 may not be permitted because the movement amount in the first region AR1 is greater than or equal to the threshold. When the portable device K moves along the arrow A4, unlocking of the door lock mechanism 31 may not be permitted because the portable device K enters the first region AR1, moves through two grid squares, and thereafter moves outward of the first region ARI without entering the second region AR2.

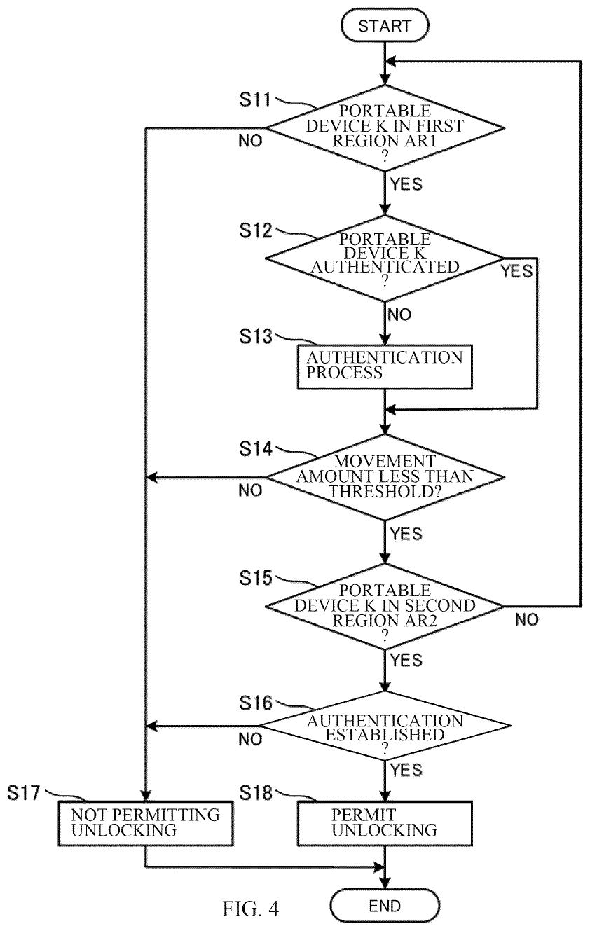

Hereinafter, an example of a process of controlling, based on a signal from the portable device K around the vehicle 100, the door lock mechanism 31 by the door lock ECU 11 configured as described above will be described with reference to the flowchart of FIG. 4. A series of processes from “START” to “END” in the flowchart illustrated in FIG. 4 may be repeatedly performed at a predetermined cycle, for example, time intervals.

When it is detected that the portable device K has entered the first region AR1 (S11), the door lock ECU 11 may determine whether the portable device K has been authenticated, or for example, whether an authentication process has already been completed (S12).

When the portable device K has been authenticated (S12: YES), the door lock ECU 11 may calculate the movement amount of the portable device K in the first region AR1 and determine whether the movement amount is less than the threshold (S14).

When the portable device K has not been authenticated (S12: NO), the door lock ECU 11 may perform the authentication process (S13), calculate the movement amount of the portable device K in the first region AR1, and determine whether the movement amount is less than the threshold (S14). Here, the case in which the authentication is not completed may include: a case in which the portable device K first enters the first region AR1, and the authentication process has not been performed between the portable device K and the communicator 22; and a case in which the authentication process is being executed.

When the movement amount of the portable device K in the first region AR1 is less than the threshold (S14: YES), the door lock ECU 11 may monitor whether the portable device K enters the second region AR2 (S15). When the movement amount of the portable device K in the first region AR1 is greater than or equal to the threshold (S14: NO), the door lock ECU 11 may end the process without permitting unlocking of the door lock mechanism 31 (S17).

When it is detected that the portable device K has entered the second region AR2 (S15: YES), the door lock ECU 11 may determine whether the authentication process in step S13 has been completed and the authentication is established (S16). When the authentication is not established (S16: NO), the door lock ECU 11 may not permit unlocking of the door lock mechanism 31 (S17), and end the process.

In contrast, when the authentication is established (S16: YES), the door lock ECU 11 may permit unlocking of the door lock mechanism 31 (S18), and end the process.

In the above example, whether the user who carries the portable device K intends to ride on the vehicle 100 may be determined based on the movement amount of the portable device K. In some embodiments, as described below, the determination may be made based on a movement time of the portable device K. In some embodiments, the determination may be made based on both the movement amount and the movement time.

In a case in which whether the user who carries the portable device K intends to ride on the vehicle 100 is to be determined based on the movement time of the portable device K, the determination is made as follows.

For example, when it is detected that the portable device K has entered the second region AR2, the door lock ECU 11 may calculate, based on the movement history of the portable device K, the movement time of the portable device K outside the second region AR2 from when the portable device K has entered the first region AR1 until when the portable device K has entered the second region AR2. The door lock ECU 11 may determine that the user who carries the portable device K does not intend to ride on the vehicle 100 when the movement time is greater than or equal to a predetermined threshold, and determine that the user intends to ride on the vehicle 100 when the movement time is less than the predetermined threshold.

Accordingly, when the movement time is greater than or equal to the predetermined threshold, the door lock ECU 11 refrains from permitting unlocking of the door lock mechanism 31 even when the authentication of the portable device K is established. In contrast, when the movement time is less than the predetermined threshold, the door lock ECU 11 may permit unlocking of the door lock mechanism 31 on condition that the authentication of the portable device K is established.

In a case in which whether the user intends to ride on the vehicle 100 is determined based on the movement time, it is possible to prevent unlocking of the door lock mechanism 31 when, for example, the user who carries the portable device K stops in the first region AR1 for a certain time period or longer.

In a case in which whether the user who carries the portable device K intends to ride on the vehicle 100 is to be determined based on both the movement amount and the movement time, the determination may be made in the following manner. Upon detecting that the portable device K has entered the second region AR2, the door lock ECU 11 may refer to the movement history of the portable device K that has been recorded in the RAM 113 and calculate the movement amount and the movement time of the portable device K in the first region ARI from when the portable device K has entered the first region AR1 until when the portable device K has entered the second region AR2.

Thereafter, when one or both of the calculated movement amount and the calculated movement time are greater than or equal to the respective predetermined thresholds, the door lock ECU 11 may determine that the user who carries the portable device K does not intend to ride on the vehicle 100. When both the calculated movement amount and the calculated movement time are less than the respective predetermined thresholds, the door lock ECU 11 may determine that the user who carries the portable device K intends to ride on the vehicle 100.

Accordingly, when one or both of the movement amount and the movement time are greater than or equal to the respective predetermined thresholds, the door lock ECU 11 refrains from permitting unlocking of the door lock mechanism 31 even when the authentication of the portable device K is established. When both the movement amount and the movement time are less than the respective predetermined thresholds, the door lock ECU 11 may permit unlocking of the door lock mechanism 31 on condition that the authentication of the portable device K is established.

According to the example embodiment of the disclosure as described above, whether the user who carries the portable device K intends to ride on the vehicle 100 may be determined, and unlocking of the door lock mechanism 31 may be permitted for the user who intends to ride on the vehicle 100, while unlocking of the door lock mechanism 31 may not be permitted for the user who does not intend to ride on the vehicle 100. With this configuration, it is possible to prevent unnecessary unlocking as much as possible. This helps to reduce power consumption of a battery mounted on the vehicle 100.

According to a door lock control apparatus of at least one example embodiment of the disclosure, it is possible to reduce power consumption by distinguishing between a user who intends to ride on a vehicle and a user who does not intend to ride on the vehicle, and preventing unnecessary unlocking as much as possible.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The CPU 111 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the CPU 111. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the CPU 111 illustrated in FIG. 1.

1. A door lock control apparatus configured to be applied to a vehicle, the door lock control apparatus being configured to control locking and unlocking of a door lock mechanism of a door of the vehicle, the door lock control apparatus comprising:
a communicator configured to mutually communicate with a portable device; and
a processor configured to control the door lock mechanism, based on a signal received from the portable device via the communicator, wherein
the processor is
configured to set a first distance that is a predetermined distance from the vehicle and a second distance shorter than the first distance, and to, when detecting that the portable device has entered a first region set to be greater than or equal to the second distance and less than the first distance, perform authentication between the portable device and the vehicle, and
configured to, when detecting that the portable device has entered a second region set to be less than the second distance from the vehicle, refrain from permitting unlocking of the door lock mechanism even when the authentication is established, provided that one or both of a movement amount and a movement time of the portable device in the first region from when the portable device has entered the first region until when the portable device has entered the second region are greater than or equal to a respective predetermined threshold.

2. The door lock control apparatus according to claim 1, wherein the processor is configured to, when the portable device is detected entering the second region and the authentication is established, permit unlocking of the door lock mechanism provided that one or both of the movement amount and the movement time of the portable device in the first region from when the portable device has entered the first region until when the portable device has entered the second region are less than the predetermined threshold.
